(19) United States
(12) Patent Application Publication
(10) Pub. No.: US 2022/0067547 A1
(43) Pub. Date: Mar. 3, 2022

(54) SMART ENVIRONMENT MITIGATION OF IDENTIFIED RISK

(71) Applicant: INTERNATIONAL BUSINESS MACHINES CORPORATION, Armonk, NY (US)

(72) Inventors: Shikhar Kwatra, San Jose, CA (US); Jeremy R. Fox, Georgetown, TX (US); Sarbajit K. Rakshit, Kolkata (IN); Craig M. Trim, Ventura, CA (US)

(21) Appl. No.: 17/008,694

(22) Filed: Sep. 1, 2020

(51) Int. Cl. G06N 5/04; G06N 20/00; G05B 19/042; G01B 11/00; G06T 7/70

(52) U.S. Cl. CPC G06N 5/04; G06N 20/00; G06Q 50/265; G01B 11/002; G06T 7/70; G05B 19/042

(57) ABSTRACT

According to a first aspect of the present invention, there is provided a computer implemented method, computer program product and computer system for a smart environment, the method including analyzing a relative position of zero or more people in the smart environment, predicting one or more possible events based on the relative position of the one or more objects and the relative position of the zero or more people, identifying a subset of events of the one or more possible events as negative risk events, calculating a risk assessment of each event of the subset of events and based on the risk assessment of each event of the subset of events being greater than a threshold, implementing a risk mitigation strategy.

### BACKGROUND

The present invention relates to a computer implemented method, data processing system and computer program product for computing, and more particularly to machine learning.

Smart environment automation is rapidly adopting across varied applications, such as business and residential applications. The increasing demand for features such as convenience of remote monitoring and operation offered by smart environment automation is expected to continue growing.

### SUMMARY

According to a first aspect of the present invention, there is provided a computer implemented method, computer program product, and computer system for a smart environment, the method including analyzing a relative position of zero or more people in the smart environment, predicting one or more possible events based on the relative position of the one or more objects and the relative position of the zero or more people, identifying a subset of events of the one or more possible events as negative risk events, calculating a risk assessment of each event of the subset of events and based on the risk assessment of each event of the subset of events being greater than a threshold, implementing a risk mitigation strategy

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts an exemplary networked computer environment according to an embodiment;

FIG. 2 depicts an operational chart illustrating a smart home according to an embodiment;

FIG. 3 is a schematic diagram of a method of operation for a smart home, according to an embodiment;

FIG. 4 depicts a block diagram of internal and external components of computers and servers depicted in FIG. 1 according to an embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to machine learning. The following described exemplary embodiments provide a system, method, and program product to, among other things, analyze an environment and calculate risk factors. Therefore, the present embodiment has the capacity to improve the technical field of machine learning by analyzing an environment, calculate potential risk factors and risk severity to perform ameliorative actions to reduce a chance of a potentially negative risk event.

As previously described, smart environment automation is rapidly adopting across varied applications, such as business and residential applications. The increasing demand for features such as convenience of remote monitoring and operation offered by smart environment automation is expected to continue growing.

An example of smart environment automation is an intelligent home system that can analyze the contextual surrounding of a home and identify a probability of a negative risk event occurring, a possible severity of the negative risk event, identify a risk mitigation strategy, provide a risk action recommendation to reduce a chance of the negative risk event occurring, such as an accident, an injury or damage, provide a post risk assessment, provide a notification mechanism and provide a responder enablement when assistance is required.

The following described exemplary embodiments provide a system, method, and program product for an intelligent environmental system which identifies risk based on known risk events, using sensor feeds analysis, visual analysis, metadata correlation, object detection and state detection using pattern analysis and risk mitigation strategy, to create a post-risk assessment, to provide responder enablement, risk action recommendation, area prediction, and a notification mechanism for a potential risk to a person, an animal, or an object.

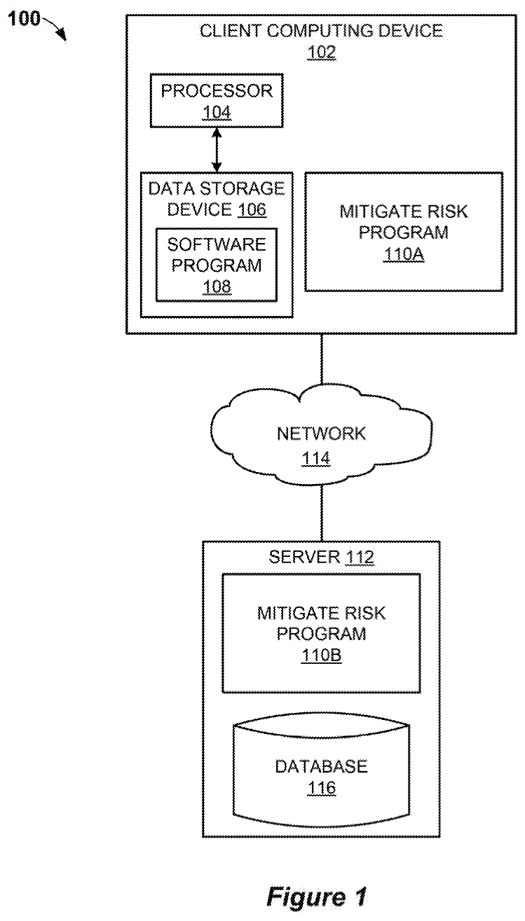

Referring to FIG. 1, an exemplary networked computer environment 100 is depicted, according to an embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

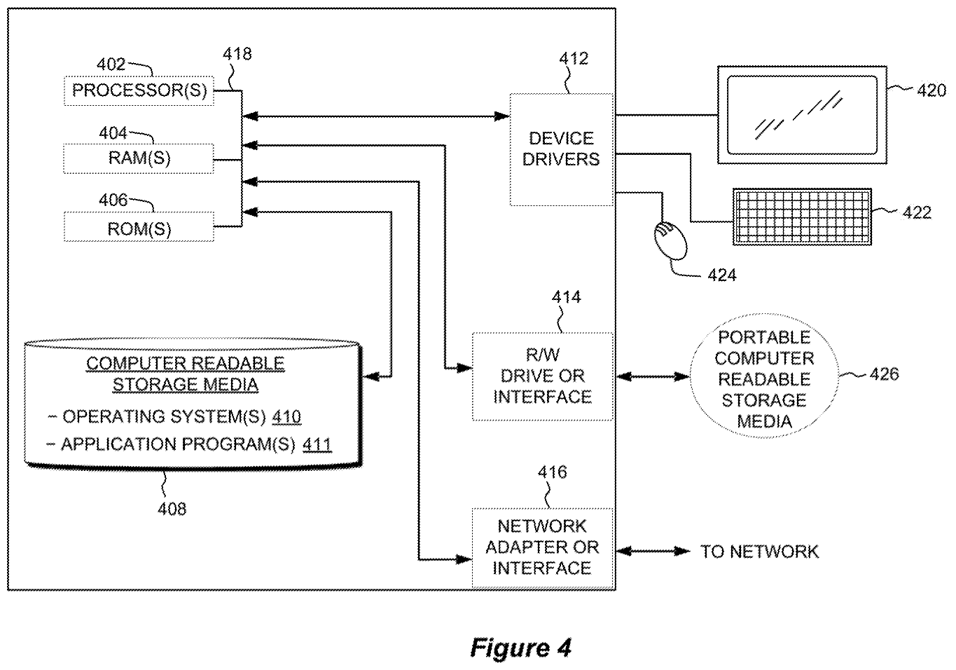

Client computing device 102 may include a processor 104 and a data storage device 106 that is enabled to host and run a software program 108 and a mitigate risk program 110A and communicate with the server 112 via the communication network 114, in accordance with an embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components and external components, respectively.

The server 112 may be a laptop computer, netbook computer, personal computer (PC), a desktop computer, or any programmable electronic device or any network of programmable electronic devices capable of hosting and running a mitigate risk program 110B and a database 116 and communicating with the client computing device 102 via the communication network 114, in accordance with embodiments of the invention. As will be discussed with reference to FIG. 4, the server 112 may include internal components and external components, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

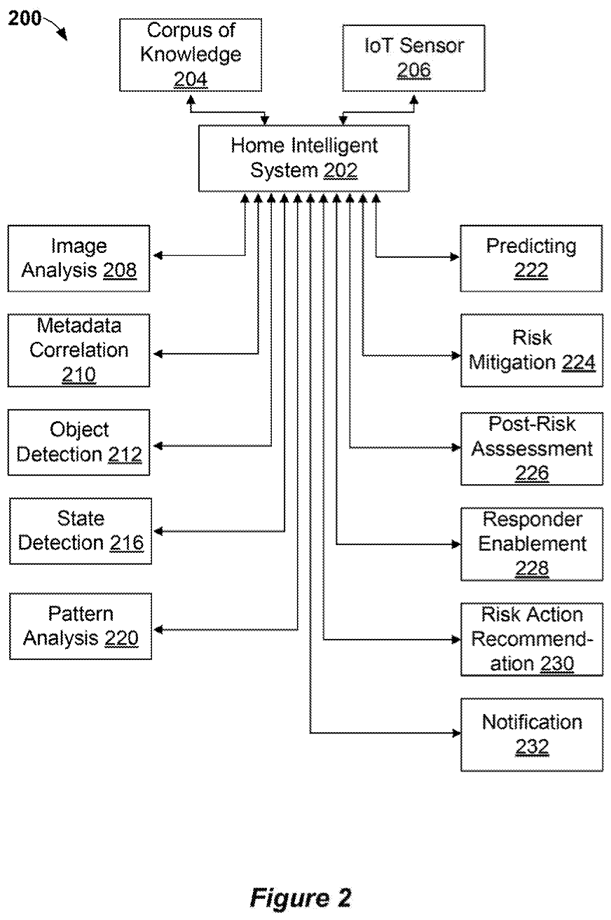

According to the present embodiment, the mitigate risk program 110A, 110B may be a program capable of identifying a potential risk in an environment and help to mitigate the risk. The smart home process method is explained in further detail below with respect to FIG. 2.

Referring now to FIG. 2, an operational chart illustrating a smart home 200 is depicted according to an embodiment. The smart home 200 may include a home intelligent system 202. System components which provide input and output to the home intelligent system 202 may include a corpus of knowledge 204, one or more Internet of Things sensors (hereinafter “IoT sensors”) 206, image analysis component 208, metadata correlation component 210, object detection component 212, state detection component 216, pattern analysis component 220, predicting component 222, risk mitigation component 224, post-risk assessment component 226, responder enablement component 228, risk action recommendation component 230 and notification component 232. Each of the system components of the smart home 200 may be an individual neural network for machine learning, (hereinafter “ML”). Alternatively, two or more of the system components of the smart home 200 may be a neural network for machine learning. Each of the system components of the smart home 200 may be connected directly over the internet, for example, the communication network 114 of FIG. 1, may be connected directly to the home intelligent system 202 or may connected to any other component of the smart home 200.

An initial training phase would occur for each neural network mechanism, and once trained, each neural network would be available for use. In an embodiment, the home intelligent system 202 would be available by a third-party application via a rest endpoint. A rest endpoint means the trained model may be accessible, for example through the internet.

The training of each neural network initiates with capturing images and visuals pertaining to objects, states and creating metadata definition wherein initially randomized set of weighted vectors are applied on said objects of interest in the training phase which are trained over multiple epochs using backpropagation to converge to optimal performance statistic.

In an embodiment, the neural networks may be re-trained on a regular cycle, for example, weekly, or every six weeks. Retraining each neural network would use the previous version of the model and ingest more data as collected during use of the smart home 200.

Various types of ML models may be built to create predictive results for various domains, such as retail, social media content, business, technology, medical, academic, government, industrial, food chain, legal or automotive. Machine learning models may also include deep learning models and artificial intelligence, (hereinafter “AI”). Training and updating a ML model may include supervised, unsupervised and semi-supervised ML procedures. Supervised learning may use a labeled dataset or a labeled training set to build, train and update a model. Unsupervised learning may use all unlabeled data to train a deep learning model. Semi-supervised learning may use both labeled datasets and unlabeled datasets to train a deep learning model.

Supervised learning and semi-supervised learning may incorporate ground truth by having an individual check the accuracy of the data, data labels and data classifications. Individuals are typically a subject matter expert (hereinafter “SME”) who have extensive knowledge in the particular domain of the dataset. The SME input may represent ground truth for the ML model and the provided ground truth may raise the accuracy of the model. The SME may correct, amend, update or remove the classification of the data or data labels by manually updating the labeled dataset. ML models improve in accuracy as datasets are corrected by a SME, however, manually annotating large amounts of data may be time-intensive and complex.

According to an embodiment, supervised or semi-supervised ML may be used to allow an individual (e.g., a user, a SME, an expert or an administrator) to have some control over the ML model by having the ability to validate, alter, update or change the training set. Users may provide input or feedback into a ML model by altering the training set as opposed to an unsupervised ML environment, when a user may not provide input to the data. The training set of data may include parameters of a classifier or a label for learning purposes and a supervised or semi-supervised ML environment may allow user to update the training set based on user experience.

Various cognitive analyses may be used, such as natural language processing (hereinafter “NLP”), semantic analysis and sentiment analysis during the building and training of a ML model. The cognitive analytics may analyze both structured and unstructured data to be incorporated into the ML process. NLP may be used to analyze the quality of data, feedback or a conversation based on the received data. Structured data may include data that is highly organized, such as a spreadsheet, relational database or data that is stored in a fixed field. Unstructured data may include data that is not organized and has an unconventional internal structure, such as a portable document format (PDF), an image, a presentation, a webpage, video content, audio content, an email, a word processing document or multimedia content. The received data may be processed through NLP to extract information that is meaningful to a user.

Semantic analysis may be used to infer the complexity, meaning and intent of interactions based on the collected and stored data, both verbal and non-verbal. For example, verbal data may include data collected by a microphone that collects the user dialog for voice analysis to infer the emotion level of the user. Non-verbal data may include, for example, text-based data or type written words, such as a social media post, a retail purchase product review, a movie review, a text message, an instant message or an email message. Semantic analysis may also consider syntactic structures at various levels to infer meaning to words, phrases, sentences and paragraphs used by the user.

Historical data and current data may be used for analysis and added to a corpus or a database that stores the training data, the real-time data, the predictive results, the user feedback and the model performance. Current data may, for example, be received from an IoT device, a global positioning system (hereinafter “GPS”), an internet protocol (hereinafter “IP”) camera, a sensor, a smart watch, a smart phone, a smart tablet, a personal computer or an automotive device. Current data may generally refer to, for example, data relating to a user's preference and a collection method to obtain the user's preferences, such as via type-written messages, video content, audio content or biometric content. Historical data may include, for example, training data, user preferences, user historical feedback, previous model performance, model performance levels for each user and model learning curves.

The home intelligent system 202 will analyze an environment, for example, a home, identify a potential risk for harm or damage to a person or animal, or to an object, and try to reduce a likelihood of a negative risk event due to the risk. When a negative risk event does occur, the home intelligent system 202 will try to address the negative risk event and provide options to address a current situation and help provide assistance to mitigate the negative risk event. The home intelligent system 202 receives inputs from, and provides outputs to, the system components including the corpus of knowledge 204, the one or more TOT sensors 206, the image analysis component 208, the metadata correlation component 210, the object detection component 212, the state detection component 216, the pattern analysis component 220, the predicting component 222, the risk mitigation component 224, the post-risk assessment component 226, the responder enablement component 228, the risk action recommendation component 230 and the notification component 232.

In an embodiment, the home intelligent system 202 will analyze a relative position of one or more objects in an environment, using a knowledge of properties of each object, an association of each object, a state of each object, and in relation to a position and a status of one or more people and/or animals in the environment. The home intelligent system 202 may make a prediction on a potential future situation which may have a negative risk event and try to prevent the negative risk event which could result in injury or damage to a person, animal or object. The home intelligent system 202 may be used in a home, an apartment building, an office, a store, a manufacturing facility, a park, among other locations.

In an embodiment, the home intelligent system 202 may use an object detection algorithm of a neural network, such as YOLO® v4, You Only Look Once, which can be trained. YOLO® is a registered trademark of Apple, Inc. The object detection algorithm is capable of simultaneous object detection and is also tagged with the Euclidean x-y coordinates using Python® library. Python® is a registered trademark of Python Software Foundation. YOLO®v4 is a convolutional neural network, (hereinafter “CNN”), for object detection and the algorithm applies a single neural network to a full image, divides the image into regions and predicts boxes and probabilities for each region. Python® library is a collection of methods and functions which allows performance of many actions which can be used for common programming tasks. For coordinates, Open CV algorithm is run in parallel and detects contours of objects and Euclidean distance to compute a distance between the objects classified in space. Open CV (Open Source Computer Vision Library) is a library of programming functions.

The corpus of knowledge 204 is a collection of pattern history for situational information, specifically used to identify a potential risk event, for example, possible situations in a home which may have a negative risk event resulting in injury or damage. The corpus of knowledge 204 is an anonymized file of people, animals, objects, in different area both indoors and outdoors, and is stored in a cloud. The corpus of knowledge 204 may have access to data of the home intelligent system 202 and all the system components of the smart home 200 and may identify events observed by the smart home 200. The corpus of knowledge 204 may identify risk events or a series of risk events, over time, including parental reactions, words spoken, and identify a resulting positive risk event, neutral risk event or negative risk event. The corpus of knowledge 204 may use Beautiful Soup, which is a Python® package which assists in scraping of information from publicly available web pages, such as the news, photos and videos which may be on the internet.

Each which occurs and is captured by the corpus of knowledge 204 event may be evaluated as a potential risk event when there is a potential negative risk event. For example, a person walking backwards down a flight of stairs may fall down, and this situation may be identified as a negative risk event by the corpus of knowledge 204. An event may be easily identified when reproduced in a similar situation. For example, if a person is walking backwards down a flight of stairs, there may be a high likelihood of the negative risk event where the person falls down. In an embodiment, the corpus of knowledge 204 may collect data from crowdsourcing, which is collecting information or input regarding a task or project by enlisting services of a large number of people, either paid or unpaid, typically via the internet. Information gathered in the current environment may be added to the corpus of knowledge 204 by users opting in via a registration module, specifically scenarios of different situations of a position of objects, people, animals and a resulting event. The corpus of knowledge 204 may continue to collect information, including information from the system components and the environment of the smart home 200.

The one or more IoT sensors 206 may each be a sensor which may be inside or outside the environment which is monitored. A sensor may be a camera, including audio and images, may be a motion sensor, a temperature sensor, a light sensor, smoke sensor, gas sensor, alcohol sensor, ultrasonic sensor, a pressure sensor, among other types of sensors. The sensor may be a PICO project sensor, which is a mnemonic used to describe a clinical or health care related question, the letters stand for patient, problem, or population; intervention; comparison, control or comparator; and outcome. Input from the one or more IoT sensors 206 may be utilized by the smart home 200 to analyze and identify a current situation in the environment. For example, the camera may capture a person stating, “watch out,” when someone is close to a hot item, or the camera may capture a person stating information such as “the hamster has escaped from its cage”. Captured information from the one or more IoT sensors 206 may be input to the home intelligent system 202, for example using NLP during the building and training of the home intelligent system 202. The one or more IoT sensors 206 may have access to data of the home intelligent system 202 and all the system components. Additionally, the one or more IoT sensors 206 may be able to communicate with people in and out of the environment. The one or more IoT sensors 206 may have as an input a spoken question, or a query by another means, such as through a cell phone, and the one or more IoT sensors 206 may provide an answer to the question or query. The response may be through a speaker or a response in kind through the cell phone messaging application. For example, a person may question a location and a current activity of a child in the environment.

The one or more IoT sensors 206 may use IBM® Screen. IBM® is a registered trademark of IBM Corp. IBM® Screen is a tool for developing and maintaining panels, panel groups, partition sets, AID tables and control tables for enterprise transaction applications, and is used to continuously stream information from the one or more IoT sensors 206 to be used by the models described below. IBM® Screen is part of IBM® Stream which is a programming language and integrated development environment (IDE) for applications, a runtime system and analytic toolkit to speed development.

The image analysis component 208 may review and identify each person, animal and object present in the environment, using input from the one or more IoT sensors 206, such as space definition, a door, a window, stairs, a plants, an item hanging on a wall, a telephone, a toy, a person, an animal, a fish tank, a piece of furniture, a chair, a light, an oven, a stove top, an electronic item, etc. The image analysis component 208 may identify a presumed composition of an item, such as metal, glass or plastic, or a combination. The image analysis component 208 may identify a size and assumed age category of a person, for example, an infant, a pre-school, an elementary aged, a teenager, an adult, a senior, a special needs person. In an embodiment, an item made of glass may be monitored as a potential item which can break. The image analysis component 208 may have access to data of the home intelligent system 202 and all the system components.

The image analysis component 208 may use YOLOv4 or a CNN algorithm. Instead of selecting interesting parts of an image, YOLOv4 or the CNN algorithm predicts classes and bounding boxes for the whole image in one run of the algorithm. The two best known examples from this group are the YOLO (You Only Look Once) family algorithms and SSD (Single Shot Multibox Detector). They are commonly used for real-time object detection as, in general, they trade a bit of accuracy for large improvements in speed.

Training of the image analysis component 208 may include feeding labeled images, for example hundreds of thousands of images for semi-supervised learning. The labeled images may be manually identified, for example, furniture which may be a chair, a table or a couch, a person, a young person, an older person, a middle aged person, a teenager, a dog, a fish in a fish tank, etc. The labeled images my be from unstructured data stored in a cloud, including data from the corpus of knowledge 204.

The YOLOv4 model can be used in pretrained way. There are pretrained yolo models available, using transfer learning they can be enhanced further using custom images and custom database. Our custom dataset is used to train the yolo model. This is a custom enhancement, which is transfer learning. The dataset is customized to our need. The YOLOv4 model input is an image and an output is an identification of the image.

The metadata correlation component 210 may provide data or metadata associated with each object identified. For example, an item made of glass may be identified as a fragile item, which may be broken easily, and a knife may be identified as a sharp object. The metadata may include a possible outcome for each object identified in a particular situation. For example, a drinking glass may break if it falls on the floor if it is made of glass or ceramic, or a person may trip on a toy on the floor. The data or metadata may correlate the object with information in the corpus of knowledge 204. The metadata may be extracted after identification of an image from the one or more IoT sensors 206, based on one of the above algorithms. Object and object coordinates may be stored in a T-value pair dictionary format using Python®, where T is a name of an object and value is data associated with the object. For example, T may be a drinking glass, and value may include fragile, broken easily. Additional examples of value may include sharp, soft, breakable, immobile, a weight, a size, a use of an item, a size of a person, an assessed age of a person, such as infant, toddler, elderly. The metadata correlation component 210 may have access to data of the home intelligent system 202 and all the system components. The values may be manually created initially.

The metadata correlation component 210 is an enhancement of modeling done as previously described, for example the YOLOv4 model or a CNN model. Using the custom dataset, i.e. transfer learning to train on custom images as described in the image analysis component 208 to label the images and the metadata correlation component 210 is used to create a Python® dictionary.

The object detection component 212 may identify a relative position of the objects in the environment using input from the image analysis component 208, the metadata correlation component 210, the one or more IoT sensors 206, and other input, and may use fast regions with convolutional neural networks (hereinafter “R-CNN”) for object detection. Fast R-CNN combines rectangular region proposals with convolutional neural network features for finding and classifying objects in an image. In an embodiment, the object detection component 212 may identify a position of items, people and animals in an environment. Information from the object detection component 212 may help to identify a potential negative risk event, such as a toy in the middle of a room, which may cause a person to trip, or a glass at an edge of a table which may easily be knocked over.

The object detection component 212 may use YOLOv4 with Open CV in parallel, and may determine Euclidean distance positioning in the environment based on determining the contours and depth imaging from a camera sensor of the one or more IoT sensors 206. More specifically, Python® may be used with Euclidean distance to compute the x-y coordinate distance and depth imaging for z distance computation. The object detection component 212 may have access to data of the home intelligent system 202 and all the system components.

Once an object is detected by the one or more IoT sensors 206, an object is identified with a label by the image analysis component 208, the metadata correlation component 210 provides values and sizes of the object, and the object detection component 212 defines sizes and spaces between objects. For example, a space between a table and a chair, and a position of a knife on the table, and a position of each person in the environment and identification of each person as a child or an adult.

This is an enhancement on machine learning and provides each object an outline or shape where it is in space. Each object may have a centroid and a contour around it.

The state detection component 216 may identify a state of an object or person or animal. For example, a state of object may include a temperature of the object, whether an object is on or off, such as a toaster, or a person walking down stairs. In an embodiment, the state detection component 216 may utilize input from the image analysis component 208 and from a camera from the one or more IoT sensors 206. The state detection component 216 may identify each person and animal in the environment. For example, a child is playing in their bedroom and an adult is cooking dinner. The state detection component 216 may use information from the one or more IoT sensors 206, from the image analysis component 208 and from the corpus of knowledge 204 for a person or animal of a similar description and also for specific accumulated knowledge of previously identified people and animals in the environment. The state detection component 216 may use information from any of the system components of the smart home 200. The state detection component 216 may identify no people, one person or more than 1 person. The state detection component 216 may identify one or more objects. The state detection component 216 may identify zero animals or one or more animals.

The state detection component 216 may use the trained YOLOv4 or a CNN algorithm as described above, and further training may include people and animals. Using an additional custom dataset, i.e. transfer learning to train on custom images as described in the image analysis component 208, to use manually labelled imaged to further enhance the Python® dictionary identifying people and animals. Identification can include characteristics as a size and contour of a person which can further identify as infant, toddler, child, school age, teenager, adult, senior. Further characteristics may include special needs of a person or an animal, for instance difficulty hearing or seeing, or difficulty moving around for example on stairs. In an embodiment, identification of people and animals may be anonymized. In an alternate embodiment, an individual may be identified by a wearable such as a smart watch or ring.

The above algorithms may be used and input from the one or more of the IoT sensors 206 may be appended with a timestamp T={t1, t2 . . . tn} across frames of a video from one or more of the IoT sensors 206, resulting in timestamped image classification. Hence an object at the time t1 defines a state of the object at t1.

The pattern analysis component 220 may identify a pattern of activity for the pets or animals in the environment. The pattern analysis component 220 may identify a location, a status, such as walking, playing, and a state, such as a body temperature, of each person and animal. The pattern analysis component 220 may identify a person who is falling or slipping, which may be a negative situation. Alternatively, if a child is playing and falling, giggling and getting back up again, this may not be a negative situation. The pattern analysis component 220 may have access to data of the home intelligent system 202 and all the system components. The pattern analysis component 220 may identify common sequences of events for a historical mobility pattern of the person or animal. For example, person A gets up at 8 am on a weekday, uses a bathroom, returns to their bedroom, changes their clothes, walks to the kitchen, prepares breakfast, etc. This may be used to predict a future pattern of movement.

The pattern analysis component 220 may use the above algorithms running which is appended with a timestamp T={t1, t2 . . . tn}, as described above. An object, O, at a time, t1, is defined with a state, S1, at t1. Regressor algorithms may be used with historical information of the states, S, for different objects, O, stored in the cloud database. A pattern history is fed as an input features in a regression algorithm for the pattern analysis component 220.

The predicting component 222 may identify possible risk events based on a current situation of people, animals and objects in the environment and calculate a risk factor or assessment for each possible risk event.

The predicting component 222 may further use the algorithms identified above and may be semi-supervised for initial training which includes manually labeled data. The predicting component 222 may provide a probability of a negative risk event occurring. The probability of a negative risk event R may be calculated using an artificial neural network where each of three weights, w1, w2 and w3, are multiplied with a vector associated with different components identified in the environment, and then added together. The weights and the vectors may be updated via back propagation.

R=f{w1*(object metadata attributes)+w2*(classified category)+w3*(person calculated)}

The probability of a negative risk event R may be a number between 0 and 1. In this equation w1, w2 and w3 are each a weight parameter and are each a number between (0-1), where 0 is a low risk probability for a negative event to occur and 1 is a high risk probability for a negative event to occur.

The weight parameter w1 is a value which emphasizes a weight value to the (object metadata attributes) and initially during training may be randomly assigned, for example an initial value may be 0.5. During back propagation while training, the weight parameter w1 gets updated to a number between 0 and 1.

The (object metadata attributes) is a vector which is a combination of metadata attributes for an object detected in the environment. A combination of an object, the object characteristics, an object location and a time stamp may provide input to the (object metadata attributes), using information from the corpus of knowledge 204, the one or more IoT sensors 206, the image analysis component 208, the metadata correlation component 210, the object detection component 212, the stat detection 215 and the pattern analysis component 220. The object is encoded, for example using One Hot Encoding or Label Encoding, which classifies the object into a numerical value. For example, a knife may be a detected object at a time stamp t1. The knife has characteristics of being sharp. The knife may have a relatively higher value as possibly contributing to a negative risk event, while a chair may have a relatively lower value as possibly contributing to a negative risk event.

The weight parameter w2 is a value which emphasizes a weight value to the (classified category) and initially during training may be randomly assigned, for example an initial value may be 0.5. During back propagation while training, the weight parameter w2 gets updated to a number between 0 and 1.

The (classified category) is a vector which is a combination of information related to a category for the object detected in the environment, using information from the corpus of knowledge 204, the one or more IoT sensors 206, the image analysis component 208, the metadata correlation component 210, the object detection component 212, the stat detection 215 and the pattern analysis component 220. For example, the object may be categorized as an appliance, a piece of furniture, a tool, a toy, a person, clothing, etc. The object is encoded, for example using One Hot Encoding or Label Encoding, which classifies the classified category into a numerical value. For example, an appliance such a toaster may be a detected object at a time stamp t1. The toaster has characteristics of getting hot when turned on. The appliance may have a relatively higher value as possibly contributing to a negative risk event, while a book may have a relatively lower value as possibly contributing to a negative risk event.

The weight parameter w3 is a value which emphasizes a weight value to the (person calculated) and initially during training may be randomly assigned, for example an initial value may be 0.5. During back propagation while training, the weight parameter w3 gets updated to a number between 0 and 1.

The (person calculated) is a vector which is a combination of information related to a person or an animal detected in the environment, using information from the corpus of knowledge 204, the one or more IoT sensors 206, the image analysis component 208, the metadata correlation component 210, the object detection component 212, the stat detection 215 and the pattern analysis component 220. For example, the person may be categorized as an infant, a toddler, a school age child, a teen, an adult, a special needs person, an elderly person, etc. The person is encoded, for example using One Hot Encoding or Label Encoding, which classifies the classified category into a numerical value. For example, a toddler may be a detected object at a time stamp t1. The toddler may have characteristics of falling and knocking things over. The toddler may have a relatively higher value as possibly contributing to a negative risk event, while an adult may have a relatively lower value as possibly contributing to a negative risk event.

In an embodiment, the weights may be categorized into 3 groupings where a value of a weight between 0 and 0.3 may be a low risk of the related vector contributing to a negative event to occur, a weight between 0.4 and 0.6 may be a medium risk of the related vector contributing to a negative event to occur and a weight between 0.7 and 1.0 may be a high risk of the related vector contributing to a negative event to occur. Alternatively, the weights may be categorized into 5 groupings, such as 0-0.2, 0.3-0.4, 0.5-0.6, 0.7-0.8, and 0.9-1.0.

In an embodiment, the negative risk event probability R may be also categorized into 3 groupings where a value of a weight between 0 and 0.3 may be a low risk of a negative risk event to occur, a weight between 0.4 and 0.6 may be a medium risk of a negative risk event to occur and a weight between 0.7 and 1.0 may be a high risk of a negative risk event to occur. Alternatively, the negative risk event probability R may be categorized into 5 groupings, such as 0-0.2, 0.3-0.4, 0.5-0.6, 0.7-0.8, and 0.9-1.0.

The probability of a negative risk event R may use information from all system components of the smart home 200. The corpus of knowledge 204 provides input including historic mobility patterns and series of events which may have a high likelihood of resulting in a negative risk event. The image analysis component 208 provides visual information of people, animals and objects in the environment. The metadata correlation component 210 provides data associated with the people, animals and objects. The object detection component 212 provides relative positions of people, animals and objects. The state detection component 216 identifies a state of an object, animal and person. The pattern analysis component 220 identifies patterns of activities among the people, animal and object. All of the system components use information from other system components for analysis. The predicting component 222 uses input from the system components to calculate a risk factor for each risk event.

In an embodiment, a risk factor higher for a risk event which is greater than 0.8 may trigger other system components, for example the risk mitigation component 224.

The predicting component 222 may analyze a historical mobility pattern of each person and animal in the environment and predict future patterns through the environment as described in the pattern analysis component 220. For example, a child may have a daily schedule for attending school. A visually impaired person may walk along a predictable path. An older person may walk more slowly. The predicting component 222 may predict a time the child is arriving home and predict a time the child walks to the kitchen for an after-school snack. The predicting component 222 for example, may help to determine a risk for a risk event because the child is going towards the kitchen when a glass is near an edge of a table, where the glass is more likely to be knocked over by a child than by an adult. The predicting component 222 may identify a risk event as a negative risk event, a positive risk event or a neutral risk event. A negative risk event may result in injury or damage to a person, animal or object. A neutral risk event may likely not result in injury or damage to a person, animal or object. A positive risk event may be beneficial to the person, animal or object. For example, a plant receives a weekly watering, which is positive for the plant.

The mobility pattern may be based on a history of each of the one or more people and animals in the environment and on the corpus of knowledge 204 for a person or animal of similar description, for example, historical information for a person A shows typically person A arrives home from work on Mondays at 4 pm and goes to the bedroom, changes their clothes, and then to the kitchen for a snack. The information for person A has been stored in the corpus of knowledge 204. The predicted mobility pattern may be based on a current location, for example, a seat at a table may be close to a glass near an edge of a table, and a person sitting at the table may have a higher probability of a risk event moving their arm and knocking the glass off the table. The predictive path or mobility pattern may be determined based on a state encountered at time t1 vs time t2 along the timestamped image classification across multiple frames as explained above.

The predicting component 222 may predict a likelihood of a negative risk event. For example, if there is a prediction of a glass falling, a tall drinking glass with thin walls may be more likely to break than a shorter drinking glass with thicker walls. A risk event of someone falling onto a carpeted floor may have a lower severity than a risk event of a fire starting. In a further example, a risk event of an elderly person who has difficulty getting up off the floor may have a higher severity than a child who frequently sits on the floor and gets up and down.

The predicting component 222 may use information from all system components of the smart home 200. The corpus of knowledge 204 provides input including historic mobility patterns and series of events which may have a high likelihood of resulting in a negative risk event. The image analysis component 208 provides visual information of people, animals and objects in the environment. The metadata correlation component 210 provides data associated with the people, animals and objects. The object detection component 212 provides relative positions of people, animals and objects. The state detection component 216 identifies a state of an object, animal and person. The pattern analysis component 220 identifies patterns of activities among the people, animal and object. The predicting component 222 uses input from the system components to calculate a risk factor for each risk event. All of the system components use information from other system components for analysis.

The predicting component 222 may predict a consequence of what may occur if the negative risk event happens. The predicting component 222 may be a trained neural network, utilizing information from the components of the smart home 200. In an embodiment, a trained model of the each of the components of the smart home 200 may be running on an edge device, for example an IP camera attached to assist processor. An edge device provides an entry point to a service provide core network, such as a router. The assist processor may communicate with IBM® Cloud Private (hereinafter “ICP”) running the training models.

An example of the predicting component 222 follows. If a glass falls off a table and there is one person in the room, or there are two people in the room, or if there is an adult in the room, or there is a child in the room, a consequence may be whom may be injured based on their location in the environment. An amount of liquid in a glass may determine how large an area has to be cleaned up. A height and a weight of the glass may determine how large an area a breaking glass may spread out to.

The predicting component 222 may make predictions using regressor algorithms once the historical information of a state for one or more objects are stored in a cloud database. Hence, pattern history is set which is fed as input features in a regression algorithm to make a prediction of a risk factor.

A prediction from the predicting component 222 of a risk factor for a risk event determined to be a negative risk event which is higher than a threshold may trigger further actions.

The predicting component 222 may use Euclidean distance based on determining the contours and depth imaging as described above and using Python® with Euclidean distance to compute the x-y coordinate distance and depth imaging for z distance computation. Regressor algorithms may be used with historical information of the states, S, for different objects, O, stored in the cloud database. A pattern history is fed as an input features in a regression algorithm for the predicting component 222.

The risk mitigation component 224 may be an output of the home intelligent system 202. The risk mitigation component 224 may be a trained neural network, utilizing information from the components of the smart home 200.

The risk mitigation component 224 may provide suggestions to reduce a risk of a risk event. The risk mitigation component 224 may initiate actions, may provide a notification by a text, email or phone call to a responsible person, may provide a verbal warning, for example on a speaker or on a television, may provide a warning light, or other means of communication to attempt to reduce a risk of a risk event. The risk mitigation component 224 may provide a notification to a user, such as a parent regarding the potential risk event of a child moving near a glass positioned at an edge of a table, and provide a notification with a suggestion to move the glass or the child. In an embodiment, a glass may have fallen on a kitchen floor and broken. The risk mitigation component 224 may close an entrance to the kitchen, for example, lock the kitchen door for a child or a pet to enter the kitchen. The risk mitigation component 224 may allow the responsible person to enter the kitchen to clean up the broken glass. In an alternative embodiment, a notification may go to the responsible person of a potentially negative situation which can be mitigated, for example, a stove in the kitchen was left on after a food item was removed from the stove. The risk mitigation component 224 may have access to data of the home intelligent system 202 and all the system components.

The risk mitigation component 224 is based on feeding the image classifier (YOLOv4 with OpenCV mentioned above) into a reinforcement learning algorithm which stores the sequence of states of the agent (the smart home 200) and takes an action. Then reward function (parameter in reinforcement learning) is updated based on the action taken by the agent (the smart home 200).

The reinforcement learning algorithms is a form of reinforcing the information from the smart home 200 and associated results from any action taken. It has a component called reward function which gets updated with positive or negative values based on the outcome of the model.

The post-risk assessment component 226 may assess a situation after a risk event which has been determined to be negative, has occurred, analyzing the environment, identifying an injury or damage. For example, after an item has broken, where are the broken pieces, do the broken pieces pose further potential danger, has a person or animal been injured. An example may be that something has fallen against a gas operated stove in a kitchen. The post-risk assessment component 226 may identify that potentially the gas feeding the stove may be leaking, and the risk mitigation component 224 may turn off a gas supply to the stove. The post-risk assessment component 226 may have access to data of the home intelligent system 202 and all the system components.

Each state of an object may be first initially assigned a particular risk value stored in the metadata piece during training, for example 0.5. The risk values get updated during training based on the similarity of other items based on an image classification falling in the same domain/spectrum or category.

The post-risk assessment component 226 is based on feeding the image classifier (YOLOv4 with OpenCV mentioned above) into the reinforcement learning algorithm which stores the sequence of states of the agent (the smart home 200) and takes an action. Then reward function (parameter in reinforcement learning) is updated based on the action taken by the agent (the smart home 200).

The responder enablement component 228 may provide output to identify an area in the environment which may be damaged or be a danger to a person or animal. For example, an area which contains broken glass may have a projection system providing a visual light on the areas which have broken glass to prevent people from stepping on the broken glass. There may be a geofenced region to highlight the unsafe area. The projection system may illuminate a safe movement path, for example a green light for the safe movement path and a red light for the unsafe movement path. The projection system may be a handheld projector, for example a Pico projector. The responder enablement component 228 may have access to data of the home intelligent system 202 and all the system components.

The responder enablement component 228 is also based on feeding the image classifier (YOLOv4 with OpenCV mentioned above) into the reinforcement learning algorithm which stores the sequence of states of the agent (the smart home 200) and takes an action. Then reward function (parameter in reinforcement learning) is updated based on the action taken by the agent (the smart home 200).

The risk action recommendation component 230 may be an output of the smart home 200 and utilizing input from the IoT sensors 206, may identify a recommended course of action for any people or animals. For example, an audio notification over a speaker may be given to leave a room, or leave the environment, or alternatively, to stay in place while a cleaning robot is enabled to clean up a mess from an unsafe situation, such as broken glass. The risk action recommendation component 230 may have access to data of the home intelligent system 202 and all the system components.

The risk action recommendation component 230 may use input from the one or more IoT sensors 206, such as depth imaging and cameras as indicated above, integrated with cloud repository where objects classification is running and storing objects, their states and creating a dictionary showcased above.

The notification component 232 provides a notification when the smart home 200 predicts a potential negative situation which may be able to be avoided. For example, a child is walking towards the kitchen and a glass is near an edge of the table, the notification component 232 may notify a responsible adult with a suggestion to move the glass towards to a more safe place to reduce a change of a risk event. In another example, an item may be cooking unattended on a stove stop, and the notification component 232 may notify a responsible adult that the item is unattended. In a further example, a lit candle may be unattended, and a child may be in a same room as the lit candle. The notification component 232 may send a request for further assistance beyond the environment. An unsafe situation which may result in a risk event may result in a notification to a responsible adult outside the environment, for example a parent at their office, or a neighbor. The notification component 232 may also request assistance in a situation where assistance from professional authorities may be needed, for example, a fire may result in a notification to a fire department, or an intruder may result in a notification to a police department. A further example is in a situation where a fire is identified in an area not expected, such as a fireplace, a stove, an oven or a candle, the smart home 200 may trigger a smoke alarm, a sprinkler system or a release of a fire retardant, in addition to notifications of a responsible adult and a fire department. The notification component 232 may have access to data of the home intelligent system 202 and all the system components.

The notification component 232 may use a regressor algorithm with reinforcement learning, as explained above.

It may be appreciated that FIG. 2 provides only an illustration of an implementation and does not imply any limitations with regard to how different embodiments may be implemented. Many modifications to the depicted environments may be made based on design and implementation requirements. The smart home 200 can identify and help reduce a chance of a risk event by providing a notification and taking substantive steps to reduce risk in an environment.

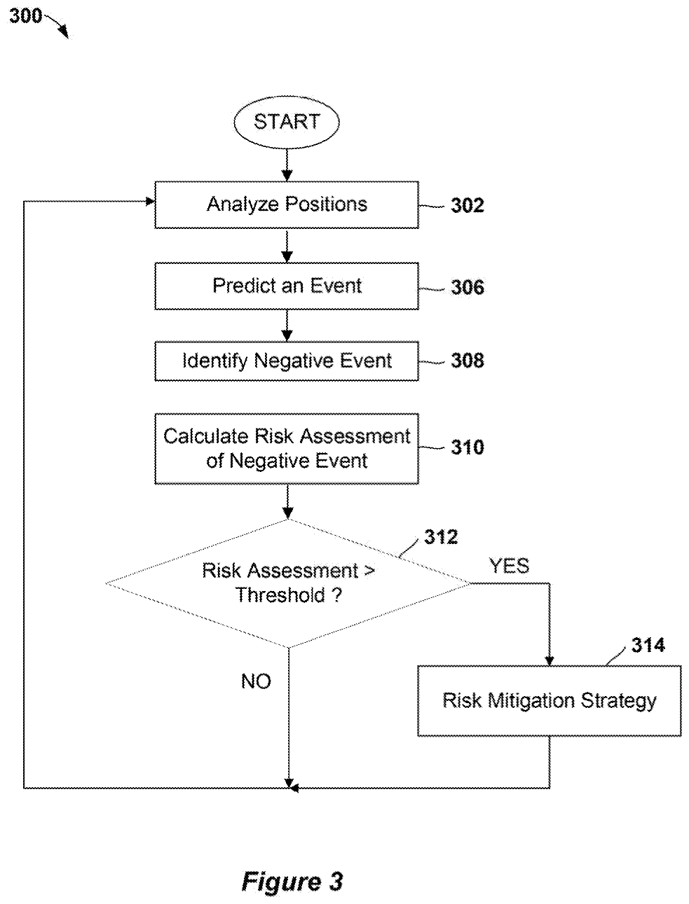

Referring now to FIG. 3, a flowchart of a method 300 of operation of the smart home 200 is shown, according to an embodiment.

At step 302, a position of each object, person and animal in the environment may be identified, as described above by the object detection component 212, and input from other system components of the smart home 200, including as the IoT sensors 206, the image analysis component 208 and the corpus of knowledge 204.

At step 306, an event may be predicted, as described above by the predicting component 222. Prediction of the event may be based on the position of each object and each person in the environment, and input from other system components of the smart home, including histories of events and people from the corpus of knowledge 204, information from the pattern analysis component 220 and the state detection component 216.

At step 308, the risk event may be classified as a negative risk event or as not a negative e risk vent. A prediction of a negative risk event may attempt to be mitigated by the smart home 200. The event may be classified based on history of a similar event which caused damage or injury to a person, animal or object, based on input from the corpus of knowledge 204 and other system components.

At step 310, a risk assessment of the negative risk event may be calculated, as described above by the predicting component 222. The calculation may be based on input from the corpus of knowledge 204 and other system components.

At step 312, a determination may be made if the risk assessment is above a threshold. If the risk assessment is above the threshold, the method 300 may continue to step 314. If the risk assessment is not above the threshold, the method 300 may continue to monitor the environment, at step 302.

Referring now to FIG. 4, a block diagram of components of a computing device, such as the server 112 of FIG. 1, in accordance with an embodiment of the present invention is shown. It should be appreciated that FIG. 3 provides only an illustration of an implementation and does not imply any limitations with regard to the environments in which different embodiments may be implemented. Many modifications to the depicted environment may be made.

The computing device may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). For example, the method 300, may be stored on the one or more of the computer readable storage media 408. In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computing device may also include the R/W drive or interface 414 to read from and write to one or more portable computer readable storage media 426. Application programs 411 on the computing device may be stored on one or more of the portable computer readable storage media 426, read via the respective R/W drive or interface 414 and loaded into the respective computer readable storage media 408.

The computing device may also include the network adapter or interface 416, such as a TCP/IP adapter card or wireless communication adapter (such as a 4G wireless communication adapter using OFDMA technology). Application programs 411 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

The computing device may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access a normalized search engine or related data available in the cloud. For example, the normalized search engine could execute on a computing system in the cloud and execute normalized searches. In such a case, the normalized search engine could normalize a corpus of information and store an index of the normalizations at a storage location in the cloud. Doing so allows a user to access this information from any computing system attached to a network connected to the cloud (e.g., the Internet).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

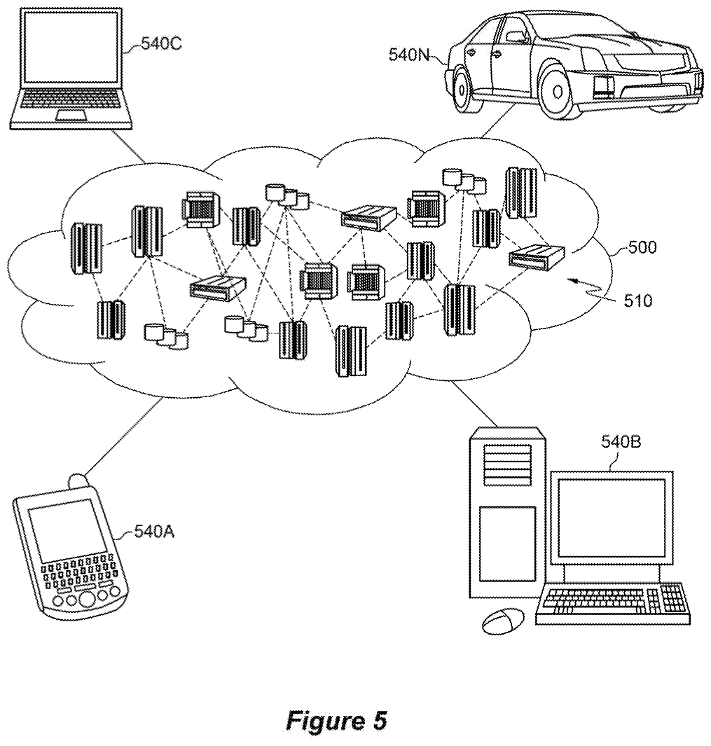

Referring now to FIG. 5, illustrative cloud computing environment 500 is depicted. As shown, cloud computing environment 500 includes one or more cloud computing nodes 510 with which local computing devices used by cloud consumers, such as, for example, personal digital assistant (PDA) or cellular telephone 540A, desktop computer 540B, laptop computer 540C, and/or automobile computer system 540N may communicate. Cloud computing nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 540A-N shown in FIG. 5 are intended to be illustrative only and that cloud computing nodes 510 and cloud computing environment 500 can communicate with any type of computerized device over any type of network and/or network addressable connection (e.g., using a web browser).

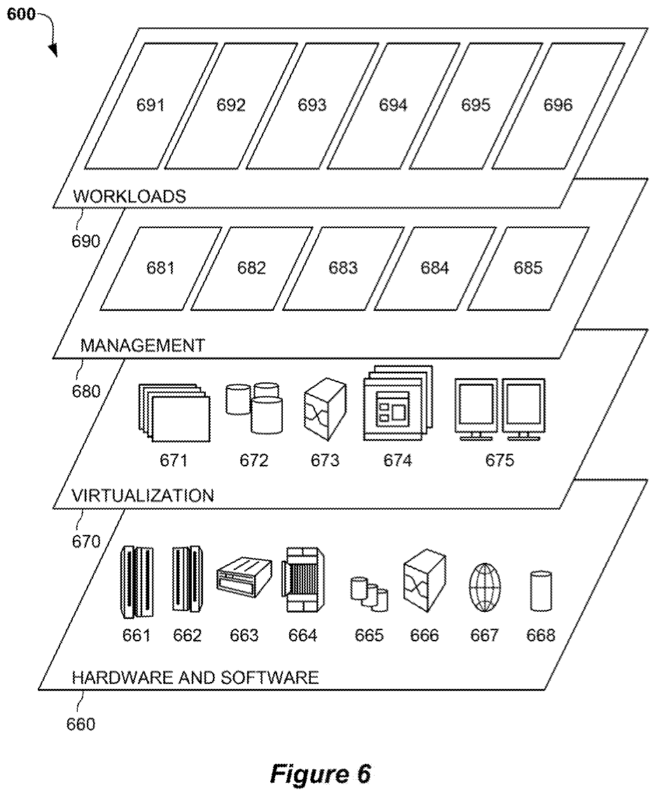

Referring now to FIG. 6, a set of functional abstraction layers provided by cloud computing environment 500 (as shown in FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672, for example the data storage device 106 as shown in FIG. 1; virtual networks 673, including virtual private networks; virtual applications and operating systems 674; and virtual clients 675.

In an example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In an example, these resources may include application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and mitigate risk program 696. The mitigate risk program 696 may assess a risk in a home and help to reduce a risk of a negative risk event such as injury or damage.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a component, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for a smart environment, the method comprising:
analyzing a relative position of one or more objects in the smart environment;
analyzing a relative position of zero or more people in the smart environment;
predicting one or more possible events based on the relative position of the one or more objects and the relative position of the zero or more people;
identifying a subset of events of the one or more possible events as negative risk events;
calculating a risk assessment of each event of the subset of events; and
based on the risk assessment of each event of the subset of events being greater than a threshold, implementing a risk mitigation strategy.

2. The processor-implemented method according to claim 1, further comprising:
analyzing a state of each of the one or more objects in the smart environment; and
analyzing a state of each of the zero or more people in the smart environment.

3. The processor-implemented method according to claim 1, wherein the risk mitigation strategy comprises notifying to a responsible adult.

4. The processor-implemented method according to claim 1, further comprising:
inputting a corpus of knowledge to the smart environment.

5. The processor-implemented method according to claim 1, further comprising:
one or more internet of things sensors inputting to the smart environment.

6. The processor-implemented method according to claim 1, further comprising:
correlating each of the one or more objects to a corpus of knowledge.

7. The processor-implemented method according to claim 1, further comprising:
calculating a severity of each event of the subset of events; and
updating the risk assessment of each event of the subset of events based on the corresponding severity.

8. A computer system for a smart environment, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
program instructions to analyze a relative position of one or more objects in the smart environment;
program instructions to analyze a relative position of zero or more people in the smart environment;
program instructions to predict one or more possible events based on the relative position of the one or more objects and the relative position of the zero or more people;
program instructions to identify a subset of events of the one or more possible events as negative risk events;
program instructions to calculate a risk assessment for each event of the subset of events; and
based on the risk assessment of each event of the subset of events being greater than a threshold, program instructions to implement a risk mitigation strategy.

9. The computer system according to claim 8, further comprising:
program instructions to analyze a state of each of the one or more objects in the smart environment; and
program instructions to analyze a state of each of the zero or more people in the smart environment.

10. The computer system according to claim 8, wherein the risk mitigation strategy comprises program instructions to a notify a responsible adult.

11. The computer system according to claim 8, further comprising:
program instructions to input a corpus of knowledge to the smart environment.

12. The computer system according to claim 8, further comprising:
program instruction to input one or more internet of things to the smart environment.

13. The computer system according to claim 8, further comprising:
program instruction to correlate each of the one or more objects to a corpus of knowledge.

14. The computer system according to claim 8, further comprising:
program instruction to calculate a severity of each event of the subset of events; and
program instruction to update the risk assessment of each event of the subset of events based on the corresponding severity.

15. A computer program product for a smart environment, the computer program product comprising:
one or more computer-readable tangible storage medium and program instructions stored on at least one of the one or more tangible storage medium, the program instructions executable by a processor, the program instructions comprising:
program instructions to analyze a relative position of one or more objects in the smart environment;
program instructions to analyze a relative position of zero or more people in the smart environment;
program instructions to predict one or more possible events based on the relative position of the one or more objects and the relative position of the zero or more people;
program instructions to identify a subset of events of the one or more possible events as negative risk events;
program instructions to calculate a risk assessment for each event of the subset of events; and
based on the risk assessment of each event of the subset of events being greater than a threshold, program instructions to implement a risk mitigation strategy.

16. The computer program product according to claim 15, further comprising:
program instructions to analyze a state of each of the one or more objects in the smart environment; and
program instructions to analyze a state of each of the zero or more people in the smart environment.

17. The computer program product according to claim 15, wherein the risk mitigation strategy comprises program instructions to a notify a responsible adult.

18. The computer program product according to claim 15, further comprising:
program instructions to input a corpus of knowledge to the smart environment.

19. The computer program product according to claim 15, further comprising:
program instruction to input one or more internet of things to the smart environment.

20. The computer program product according to claim 15, further comprising:
program instruction to calculate a severity of each event of the subset of events; and
program instruction to update the risk assessment of each event of the subset of events based on the corresponding severity.
